(19) United States
(12) Patent Application Publication
(10) Pub. No.: US 2022/0050207 A1
(43) Pub. Date: Feb. 17, 2022

(54) LIGHT PROJECTING DEVICE, TOF SENSOR PROVIDED WITH SAME AND DISTANCE IMAGE GENERATOR

(71) Applicant: OMRON CORPORATION, Kyoto-shi, Kyoto (JP)

(72) Inventors: Hideki CHUJO, Otokuni-gun (JP); Masahiro KINOSHITA, Kyoto-shi (JP); Akihiro ISHII, Ichinomiya-shi (JP)

(73) Assignee: OMRON CORPORATION, Kyoto-shi, Kyoto (JP)

(21) Appl. No.: 17/436,090

(22) PCT Filed: Feb. 6, 2020
(86) PCT No.: PCT/JP2020/004621

§ 371 Date: Sep. 3, 2021

(30) Foreign Application Priority Data
Mar. 15, 2019 (JP) JP2019-048180

(51) Int. Cl. G01S 17/894; H05B 45/305; G01S 17/10

(52) U.S. Cl. CPC G01S 17/894; G01S 17/10; H05B 45/305

(57) ABSTRACT

A light projecting device may include an LED, an LED power supply, and a drive circuit. The LED emits light in a specific direction. The LED power supply supplies power to the LED. The drive circuit subjects the waveform of the drive current modulated at a specific frequency to DC offset and inputs the result to the LED.

### TECHNICAL FIELD

The present invention relates, for example, to a light projecting device used as a light source in a TOF (time of flight) sensor, and to a TOF sensor provided with this light projecting device and a distance image generator.

### BACKGROUND ART

TOF sensors have been used in recent years to measure the distance to a measurement target by receiving the reflected light of the light emitted from an LED (light emitting diode) light source toward the measurement target.

Such a TOF sensor measures the distance to a measurement target by emitting light modulated at a specific frequency from an LED toward the measurement target, and measuring the time of flight of the light until the reflected light coming back from the measurement target is received.

For example, Patent Literature 1 discloses a distance sensor that reduces the decrease in distance measurement accuracy with respect to temperature changes in measuring the distance to an object.

### CITATION LIST

### Patent Literature

Patent Literature 1: JP-A 2017-53769

### SUMMARY

### Technical Problem

However, the following problems are encountered with the above-mentioned conventional ranging device.

Specifically, with the distance sensor disclosed in the above-mentioned publication, a light emission control signal including a zero point is inputted to a light emitting element (an LED or the like).

In this case, since high-frequency distortion tends to occur in the drive current modulated at a specific frequency, the luminance of the emitted light varies non-linearly with respect to the drive current inputted to the LED, and the waveform of the emitted light may be distorted.

### Solution to Problem

It is an object of the present invention to provide a light projecting device with which the distortion of emitted light can be effectively suppressed, as well as a TOF sensor and a distance image generation device provided with the same.

The light projecting device according to the first invention comprises an LED, a power supply unit, and a drive circuit. The LED emits light in a specific direction. The power supply unit supplies power to the LED. The drive circuit subjects the waveform of a drive current modulated at a specific frequency to DC offset and inputs the result to the LED.

Here, the drive circuit performs control such that the waveform of the drive current inputted to the LED undergoes DC offset.

Here, the drive current is processed at a specific modulation frequency and inputted to the LED. At this point, the amount of light with respect to the drive current processed at the modulation frequency may have a non-linear region, particularly near the zero point, and distortion may occur in the waveform of the light emitted from the LED.

Therefore, when the light projecting device is used as the light source of a TOF sensor, for example, if the waveform of the light emitted from the LED is distorted, there may be error in the distance to the measurement target measured by the TOF sensor.

In view of this, with the light projecting device of the present invention, the drive circuit subjects the waveform of the drive current to DC offset and inputs the result to the LED so as to avoid the vicinity of the zero point of the waveform of the amount of light for a drive current in which a non-linear region is likely to occur.

Consequently, the DC offset makes it unlikely that a non-linear region will occur in the waveform of the amount of light with a drive current inputted while avoiding the vicinity of the zero point, so distortion in the waveform of the light emitted from the LED can be effectively reduced.

As a result, even when the device is used as the light source for a TOF sensor or the like, for example, the accuracy of distance measurement can be improved if the LED emits light having a waveform in which the occurrence of distortion is reduced.

The light projecting device according to the second invention is the light projecting device according to the first invention, wherein the drive circuit has an offset generation circuit that subjects the drive current to DC offset.

Here, the offset generation circuit provided to the drive circuit generates a signal that subjects the drive current inputted to the LED to DC offset.

Consequently, the drive current can undergo DC offset on the basis of the offset signal generated in the offset generation circuit.

The light projecting device according to the third invention is the light projecting device according to the first or second invention, wherein the drive circuit inputs a drive current modulated by a frequency of at least 4 MHz to the LED.

Here, a frequency of at least 4 MHz is used as the modulation frequency of the drive current inputted to the LED.

Consequently, in the relationship between the drive current processed at a modulation frequency of at least 4 MHz and the amount of light, a non-linear region tends to occur mainly near the zero point, but the above-mentioned DC offset makes it less likely that there will be a non-linear region in the waveform of the amount of light with respect to the drive current.

Consequently, it is possible to effectively suppress the occurrence of distortion in the waveform of the light emitted from the LED driven by a drive current processed at a modulation frequency of at least 4 MHz.

The light projecting device according to the fourth invention is the light projecting device according to any of the first to third inventions, wherein the drive circuit inputs a sine wave drive current to the LED.

Here, the drive current inputted to the LED is inputted as a sine wave through a low-pass filter, for example.

Consequently, since DC offset is performed in order to suppress the occurrence of a non-linear region near the zero point of the sine wave of the amount of light with respect to the drive current, it is possible to effectively suppress the inclusion of distortion in the waveform of the light emitted from the LED.

The TOF sensor according to the fifth invention comprises the light projecting device according to any of the first to fourth inventions, a light receiving unit, and a measurement unit. The light receiving unit receives the reflected light of the light emitted from the light projecting device toward the measurement target. The measurement unit measures the distance to the measurement target on the basis of the time of flight of the light from when the light is emitted from the light projecting device until the reflected light is received by the light receiving unit.

Here, a TOF (time of flight) sensor is configured such that the reflected light of the light emitted from the above-mentioned light projecting device is received by the light receiving unit, and the measurement unit measures the distance to the measurement target on the basis of the time of flight of the light from emission until reception.

Consequently, even when the above-mentioned light projecting device is used as the light source in a TOF sensor, since the LED emits light having a waveform in which the occurrence of distortion is suppressed, the measurement accuracy of the distance measured by the TOF sensor can be improved.

The distance image generator according to the sixth invention comprises the TOF sensor according to claim 5, wherein the light receiving unit is a light receiving element having a plurality of pixels, and the measurement unit measures the distance to the measurement target in each of the plurality of pixels included in the light receiving element, on the basis of the time of flight of the light until the reflected light is received. There is further provided an image generation unit that generates a distance image by using the distance to the measurement target measured in each of the plurality of pixels.

Here, a distance image generator including the TOF sensor discussed above is configured.

Consequently, even when a distance image generation device is configured by using a TOF sensor that includes the above-mentioned light projecting device, since light having a waveform in which the occurrence of distortion is suppressed will be emitted from the light projecting device (LED), the accuracy of the distance measured by the TOF sensor can be improved.

Consequently, the accuracy of the distance image generated by using the distance data measured by the TOF sensor can also be improved.

### Advantageous Effects

With the light projecting device according to the present invention, distortion of the projected light can be effectively reduced.

### BRIEF DESCRIPTION OF DRAWINGS

FIG. 1 is a control block diagram showing the configuration of a distance image generation device including a TOF sensor having the light projecting device according to an embodiment of the present invention;

FIG. 2 is a diagram illustrating the principle of measuring the distance to a measurement target with the TOF sensor included in the distance image generator in FIG. 1;

FIG. 3 is a control block diagram of the light projecting device included in the TOF sensor in FIG. 1;

FIG. 4 is a graph of a non-linear portion occurring in the relationship between the drive current of an LED and the amount of light;

FIG. 5A is a graph of the current waveform corresponding to the drive current in FIG. 4 and the optical waveform emitted from an LED, and FIG. 5B is a graph in which this current waveform and optical waveform are shown superimposed; and

FIG. 6A is a graph of the current waveform corresponding to a current waveform in which the drive current in FIG. 4 has undergone DC offset, and the optical waveform emitted from an LED, and FIG. 6B is a graph in which this current waveform and optical waveform are shown superimposed.

### DESCRIPTION OF EMBODIMENTS

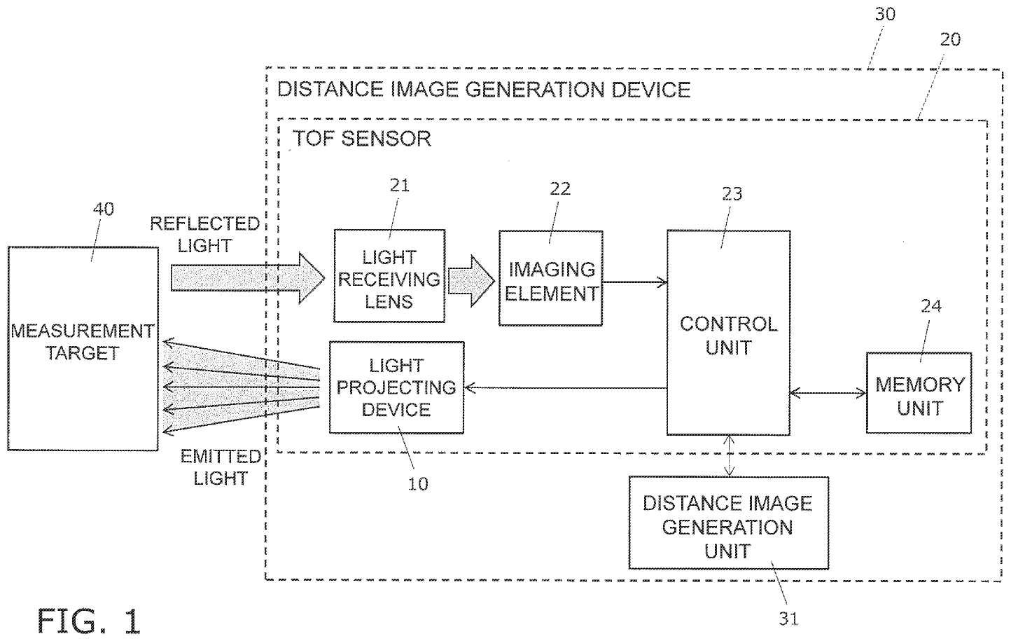

A distance image generation device 30 including a TOF sensor 20 comprising a light projecting device 10 according to an embodiment of the present invention will now be described with reference to FIGS. 1 to 6B.

### (1) Configuration of Distance Image Generation Device 30

With the distance image generation device 30 according to this embodiment, an imaging element 22 receives the reflected light of the light emitted from the light projecting device 10 included in the TOF sensor 20 toward a measurement target 40, and a distance image displaying the distance to the measurement target 40 is generated according to the time of flight (TOF) of the light from the time when the light is emitted until being received. As shown in FIG. 1, the distance image generation device 30 comprises the TOF sensor 20 and a distance image generation unit 31.

The distance image generation unit 31 produces a distance image including the distance information measured for each of a plurality of pixels of the imaging element 22, on the basis of the time difference (time of flight) between the timing at which each pixel of the imaging element 22 included in the TOF sensor 20 receives the reflected light from the measurement target 40, and the timing at which the light corresponding to this reflected light is emitted from the LEDs 15.

### (2) Configuration of TOF Sensor 20

The TOF sensor 20 receives the reflected light of the light emitted from the light projecting device 10 toward the measurement target 40, and displays the distance to the measurement target 40 according to the time of flight (TOF) of the light from emission until reception. As shown in FIG. 1, the TOF sensor 20 comprises the light projecting device 10, a light receiving lens 21, the imaging element (light receiving element) 22, a control unit (measurement unit) 23, and a memory unit 24.

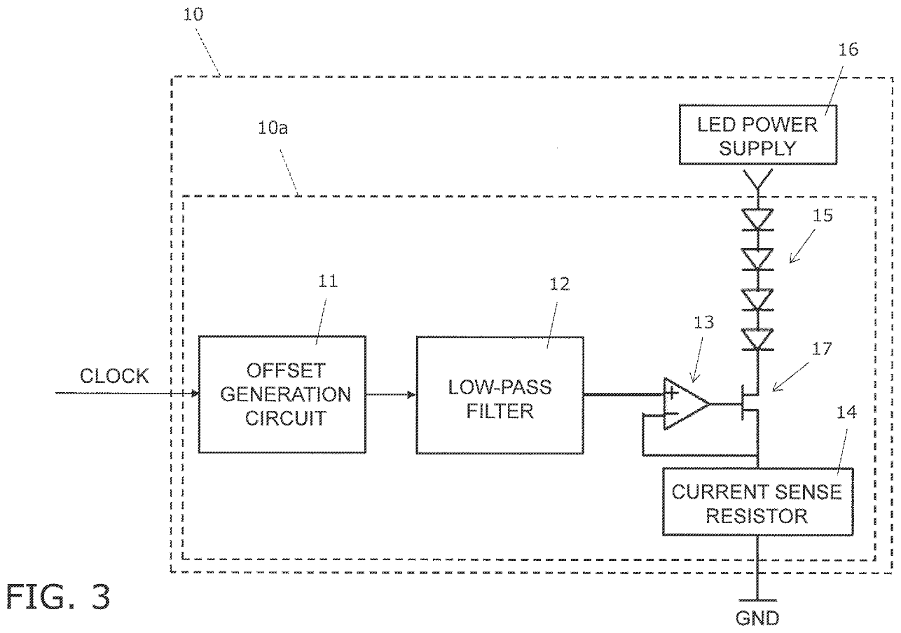

The light projecting device 10 has LEDs 15 (see FIG. 3), and irradiates the measurement target 40 with the desired light that has been processed at a modulation frequency of 12 MHz, for example. The light projecting device 10 is provided with a light projecting lens (not shown) that collects the light emitted from the LEDs 15 and guides this light in the direction of the measurement target 40. The detailed configuration of the light projecting device 10 will be described in detail below.

The light receiving lens 21 is provided in order to receive the light that is emitted from the light projecting device 10 toward the measurement target 40 and is then reflected by the measurement target 40, and to guide this light to the imaging element 22.

The imaging element (light receiving element) 22 has a plurality of pixels, and as shown in FIG. 1, the reflected light received by the light receiving lens 21 is received at each of the plurality of pixels, and a photoelectric signal that has undergone photoelectrically conversion is transmitted to the control unit 23.

As shown in FIG. 1, the control unit 23 is connected to the light projecting device 10, the imaging element 22, the memory unit 24, and the distance image generation unit 31. The control unit 23 reads various programs stored in the memory unit 24 and controls the emission of light from the light projecting device 10. Furthermore, the control unit 23 receives data such as the timing at which light is received by the plurality of pixels included in the imaging element 22, and measures the distance to the measurement target 40 on the basis of the time of flight of the light from when the light is emitted from the light projecting device 10 toward the measurement target 40 until the reflected light is received at the imaging element 22. The measurement result is transmitted from the control unit 23 to the distance image generation unit 31, and the distance image generation unit 31 generates a distance image by using distance data corresponding to each pixel of the imaging element 22.

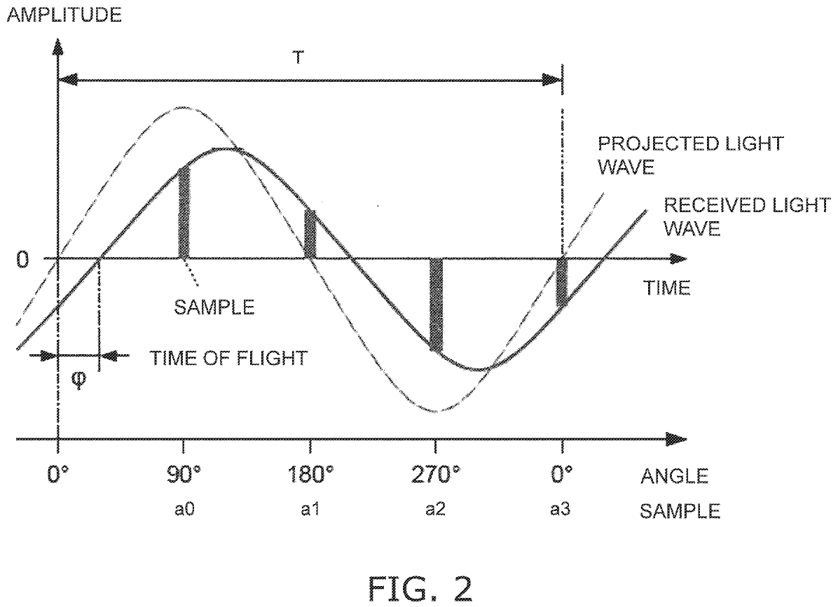

With the TOF sensor 20 in this embodiment, as shown in FIG. 2, the control unit 23 calculates the distance from the TOF sensor 20 to the measurement target 40 on the basis of the phase difference Φ between the projected light wave emitted from the light projecting device 10 and received light wave received by the imaging element 22.

Here, the phase difference D is represented by the following relational expression (1).

Φ=atan(y/x) (1)

(x=a2−a0, y=a3−a1, and a0 to a3 are amplitudes at points where the received light wave was sampled four times at 90-degree intervals.)

The conversion formula from the phase difference Φ to the distance D is expressed by the following relational formula (2).

D=(c/(2×f_{LED}))×(Φ/2π)+D_{OFFSET} (2)

(c is the speed of light (≈3×10⁸ m/s), f_{LED} is the frequency of the LED projected light wave, and D_{OFFSET} is the distance offset.)

As shown in FIG. 1, the memory unit 24 is connected to the control unit 23, and holds a control program for controlling the light projecting device 10 and the imaging element 22, and data such as the amount of reflected light detected by the imaging element 22 and the light reception timing.

### (3) Configuration of Light Projecting Device 10

The light projecting device 10 in this embodiment is a device that projects the light emitted from the LEDs 15 onto the measurement target 40, and has the following configuration in order to emit the light with as little distortion as possible. More specifically, as shown in FIG. 3, the light projecting device 10 comprises the LEDs 15, an LED power supply (power supply unit) 16, and an LED drive circuit (drive circuit) 10a.

As shown in FIG. 3, the LED drive circuit 10a has an offset generation circuit 11, a low-pass filter 12, an operational amplifier 13, a current sense resistor 14, and an FET (field effect transistor) 17, and performs control so that the drive current inputted from the power supply 16 to the LEDs 15 is subjected to DC offset.

The offset generation circuit 11 receives, for example, a clock signal composed of a pulse signal of 0.3 V at 12 MHz, performs offset processing for the DC offset of the drive current inputted to the LEDs 15, and then transmits the result to the low-pass filter 12.

The low-pass filter 12 removes any high-frequency component exceeding a specific cutoff frequency from the offset-processed pulse signal received from the offset generation circuit 11, allowing only the low-frequency component to pass, and the sine wave signal waveform thus produced is outputted to the non-inverting input terminal (+) of the operational amplifier 13.

The operational amplifier 13 is provided in order to control the FET 17, and the output (DC-offset signal) from the low-pass filter 12 is inputted to the non-inverting input terminal (+), and the feedback voltage generated in the current sense resistor 14 is inputted to the inverting input terminal (−).

The current sense resistor 14 is directly connected to the LEDs 15 and the FET 17, and is provided in order to sense the current flowing through the LEDs 15.

The LEDs 15 are configured by connecting n-number of LEDs in series, and emit light upon the application of a voltage higher than the total forward voltage n·Vf of the n-number of LEDs from the LED power supply 16.

Although not shown in FIG. 3, it is assumed that a projection lens that collects the light emitted from the LEDs 15 and projects the light onto the measurement target 40 is provided in the vicinity of the LEDs 15.

The LED power supply 16 is connected in series with the LEDs 15 and applies the voltage n·Vf.

The FET 17 is controlled by the operational amplifier 13 so that the voltage generated in the current sense resistor 14 will match the voltage inputted from the low-pass filter 12. Consequently, a drive current corresponding to the voltage inputted from the low-pass filter 12 flows to the LEDs 15 at a timing that matches the signal inputted from the low-pass filter 12.

With the light projecting device 10 in this embodiment, as described above, the operational amplifier 13 is used to feed back the voltage from the current sense resistor 14, which means that very accurate constant current drive is performed, and that the drive current can be inputted in a state of DC offset with respect to the LEDs 15 by using the offset generation circuit 11.

### Offset Processing of Current Waveform Input to LEDs 15

With the light projecting device 10 in this embodiment, light is projected from the LEDs 15 onto the measurement target 40 via a light projecting lens (not shown) with the above configuration. As mentioned above, the light projecting device 10 of this embodiment is provided with the offset generation circuit 11 in order to subject the drive current inputted to the LEDs 15 to DC offset.

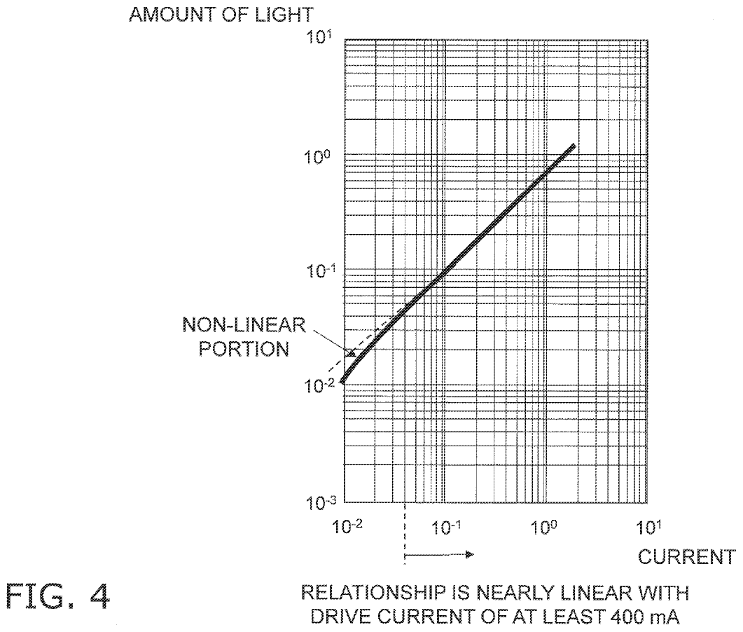

Here, as shown in FIG. 4, the light projected from the LEDs 15 includes a portion in which the amount of light (luminance) is non-linear, particularly in the region near the zero point where the inputted drive current is low (such as less than 400 mA).

Thus, if a portion is included where the amount of light with respect to the input current is non-linear, the modulated light emitted from the LEDs 15 will be distorted, and the accuracy of the distance measurement by the TOF sensor 20 that uses this light to perform distance calculation may decrease.

On the other hand, if the drive current is 400 mA or higher, as shown in FIG. 4, the current waveform will be substantially linear, and will become increasingly linear as the value of the drive current rises.

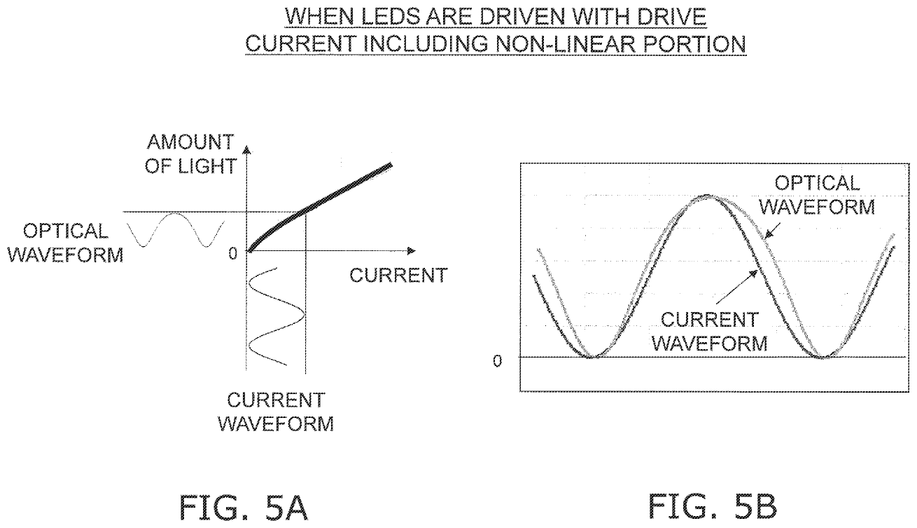

FIG. 5A is a graph of the current waveform corresponding to the drive current in the graph shown in FIG. 4, and the optical waveform emitted from the LED, and FIG. 5B is a graph in which the current waveform and the optical waveform are shown superimposed. That is, FIGS. 5A and 5B show an optical waveform in which distortion occurs when the LEDs 15 are driven while the waveform of the amount of light with respect to the drive current includes a non-linear region.

That is, since a non-linear portion in the relationship between the drive current and the amount of light is included near the zero point, as shown in FIG. 5B, even if the drive current is driven by a sine wave, the optical waveform (the amount of light) outputted from the LEDs 15 will be distorted.

With the light projecting device 10 in this embodiment, the focus is on the non-linearity between the drive current inputted to the LEDs 15 and the luminance (amount of light) of the light emitted from the LEDs 15, and improving this suppresses distortion in the light emitted from the LEDs 15.

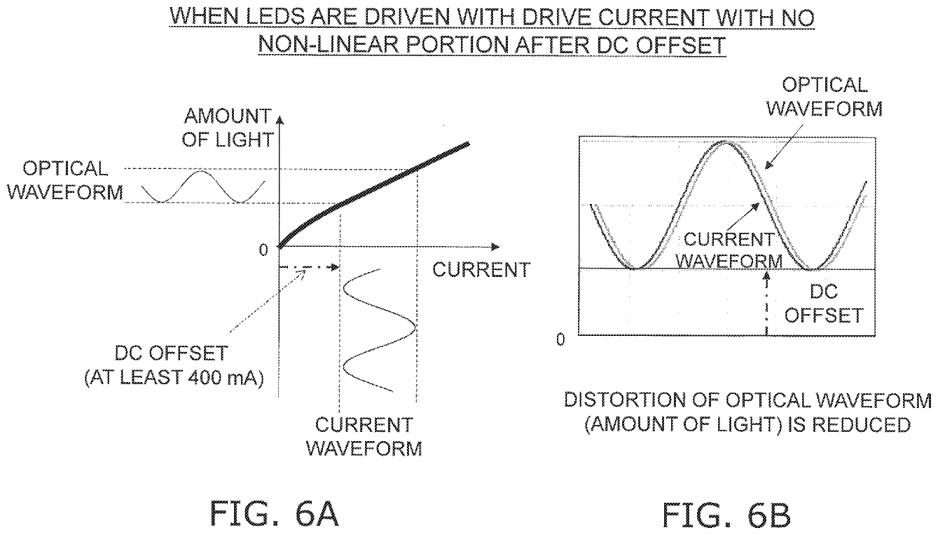

More specifically, as shown in FIG. 6A, the offset generation circuit 11 performs offset processing so that the DC offset will be at least 400 mA in order to keep the waveform showing the relationship between the drive current inputted to the LEDs 15 and the amount of light away from the vicinity of the zero point including the non-linear region, and thereby use only the linear region.

Consequently, as shown in FIG. 6B, the optical waveform corresponding to the current waveform of the DC-offset drive current can be made into an optical waveform with almost no distortion, as compared to the optical waveform shown in FIG. 5B.

As a result, since the measurement target 40 can be irradiated with light from the LEDs 15 whose distortion has been suppressed, measurement error in the distance calculated by the TOF sensor 20 can be eliminated, and measurement accuracy can be improved.

Here, if the offset amount of the drive current set in the offset generation circuit 11 at least 400 mA, then the larger is the offset amount, the more the influence of the non-linear region of the light amount waveform on the drive current can be curtailed, and the more the distortion of the optical waveform is eliminated. However, as the offset amount increases, the power consumption of the LEDs 15 also goes up, so it is preferable to set the offset amount by taking into account a good balance between the elimination of distortion of the optical waveform and power consumption.

Since this offset processing of the drive current is canceled out by subtraction in the calculation of the distance to the measurement target 40 by the TOF sensor 20, there is no effect on distance measurement.

### Other Embodiments

An embodiment of the present invention was described above, but the present invention is not limited to or by the above embodiment, and various modifications are possible without departing from the gist of the invention.

(A)

In the above embodiment, a configuration example was given in which the drive current of the sine wave generated through the low-pass filter 12 was inputted to the LEDs 15, but the present invention is not limited to this.

For instance, the present invention can be applied to a configuration in which a square wave drive current is inputted to the LEDs.

Here again, the same effect as above can be achieved, namely, that the rectangular wave will be less likely to include a non-linear region near the zero point of the amount of light with respect to the drive current, and that the inclusion of distortion in the waveform of the light emitted from the LEDs driven by this drive current can be effectively suppressed.

(B)

In the above embodiment, an example was given in which a frequency of 12 MHz was used as the modulation frequency of the drive current inputted to the LEDs 15, but the present invention is not limited to this.

For instance, the modulation frequency may be a frequency higher than 12 MHz, such as 24 MHz, or a frequency lower than 12 MHz, such 4 MHz or higher.

(C)

In the above embodiment, an example was given in which the DC offset amount of the drive current inputted to the LEDs 15 was set to at least 400 mA, but the present invention is not limited to this.

For instance, a DC offset amount of less than 400 mA may be set according to how much the light distortion needs to be suppressed.

(D)

In the above embodiment, a configuration example was given in which the control unit 23 of the TOF sensor 20 also served as the control unit of the distance image generation device 30, but the present invention is not limited to this.

For instance, the distance image generator side may also be provided with a control unit, separately from the control unit on the TOF sensor side.

(E)

In the above embodiment, an example was given in which the light projecting device 10 was used as the light source in the distance image generation device 30 including the TOF sensor 20, but the present invention is not limited to this.

For instance, this light projecting device may be used as a light source for a monocular distance sensor that measures the distance to a measurement target, instead of a distance image generation device. In this case, a light receiving element is used instead of an imaging element.

Alternatively, this light projecting device may be used as a light source for various devices other than a TOF sensor, as long as it is a device that requires irradiation of light with little distortion.

### INDUSTRIAL APPLICABILITY

The light projecting device of the present invention has the effect of allowing the distortion of projected light to be effectively suppressed, and therefore can be widely applied as a light source in various kinds of sensor, such as a TOF sensor, for example.

### REFERENCE SIGNS LIST

10 light projecting device
10a LED drive circuit (drive circuit)
11 offset generation circuit
12 low-pass filter
13 operational amplifier
14 current sense resistor
15 LED
16 LED power supply (power supply unit)
17 FET
20 TOF sensor
21 light receiving lens
22 imaging element
23 control unit
24 memory unit
30 distance image generation device
31 distance image generation unit
40 measurement target

1. A light projecting device, comprising:
an LED configured to emit light in a specific direction;
a power supply unit configured to supply power to the LED; and
a drive circuit configured to subject a waveform of a drive current modulated at a specific frequency to DC offset and input the result to the LED.

2. The light projecting device according to claim 1,
wherein the drive circuit has an offset generation circuit configured to subject the drive current to DC offset.

3. The light projecting device according to claim 1,
wherein the drive circuit inputs the drive current modulated by a frequency of at least 4 MHz to the LED.

4. The light projecting device according to claim 1,
wherein the drive circuit inputs a sine wave drive current to the LED.

5. A time of flight (TOF) sensor, comprising:
the light projecting device according to claim 1,
a light receiving unit configured to receive a reflected light of the light emitted from the light projecting device toward a measurement target; and
a measurement unit configured to measure a distance to the measurement target on the basis of a time of flight of the light from when the light is emitted from the light projecting device until the reflected light is received by the light receiving unit.

6. A distance image generator, comprising
the TOF sensor according to claim 5,
wherein the light receiving unit is a light receiving element having a plurality of pixels,
the measurement unit measures the distance to the measurement target in each of the plurality of pixels included in the light receiving element, on the basis of the time of flight of the light until the reflected light is received, and
further comprising an image generation unit configured to generate a distance image by using the distance to the measurement target measured in each of the plurality of pixels.
